(19) United States
(12) Patent Application Publication
(10) Pub. No.: US 2014/0188885 A1
(43) Pub. Date: Jul. 3, 2014

(54) Utilization and Power Efficient Hashing

(71) Applicant: BROADCOM CORPORATION, Irvine, CA (US)

(72) Inventors: Abhay Kulkarni, Bangalore (IN); Bhupesh Ramchandani, Bangalore (IN)

(73) Assignee: Broadcom Corporation, Irvine, CA (US)

(21) Appl. No.: 13/728,812

(22) Filed: Dec. 27, 2012

(51) Int. Cl. G06F 17/30

(52) U.S. Cl. CPC G06F 17/30598
USPC 707/739

(57) ABSTRACT

Methods, systems, and computer readable storage medium embodiments for hashing with improved utilization and power efficiency are disclosed. Some embodiments include inserting a key in a selected bucket in accordance with an bucket identifier generated by a hash function, wherein the selected bucket is one of a plurality of buckets of a hash table configured in at least one memory, determining respective unique bit strings based upon corresponding bit positions for a plurality of keys in the selected bucket including the inserted key, inserting the respective unique bit strings in a table location corresponding to the bucket identifier, wherein the table location is one of a plurality of table locations in at least one control table configured in the at least one memory. Other embodiments include lookup operations in a hash table.

### BACKGROUND

1. Field of the Invention

Embodiments relate to hash tables in processor-based devices.

2. Background Art

Hash tables are used in numerous applications, including applications such as network routing, access control, database access, and the like. In network routing and/or access control, for each packet that enters a network router or forwarding device, an input key is formed based upon one or more fields in the packet and that input key is compared to a hash table in order to determine an action to be taken with respect to that packet. As networks grow, the hash tables may grow larger and may consume relatively large amounts of power.

A “hash function” is used to convert input data into fixed size data. The input data may be referred to as the “key.” The hash function may convert the key into a value that maps to a location in a corresponding hash table at which desired data value(s) may be stored or accessed.

A location that is identified by a value produced by a hash function in a hash table may be referred to as a “bucket.” Consequently, the value produced by the hash function may be referred to as a “bucket identifier.” A bucket may store one or more entries. Although a bucket may hold multiple entries, eventually the hash function may associate more keys with a specific bucket identifier than there are entries contained within the corresponding bucket. In such a case, it may be impossible to store a subsequent data value within the bucket. Such a circumstance is referred to, for example, as a “miss.” Consequently, a metric known as the “first miss utilization (FMU)” is used to describe efficiency or other utility of a given hash table and associated hashing techniques. The FMU refers to the first such miss that occurs during population or other access of the hash table.

Hash table performance may be evaluated based upon metrics such as utilization and power efficiency. Utilization of a hash table can be benchmarked by the FMU. Power efficiency is effectively the power consumed in implementing a hash table. The power consumed has two parts to it: leakage power and dynamic power. Leakage power depends upon technology and hash table configuration, and increases with the width of the hash table. Dynamic power is mostly the read power. Writes are generally assumed to be less frequent for most hash table applications.

Conventional hash systems use wider buckets in order to improve the FMU. However, when the bucket width is increased, the power consumption leakage power) is increased. The read power consumption in conventional hash systems can be high because of higher bucket sizes and because the entire wide bucket is read into memory when an entry in the bucket is being accessed.

In order to address the ongoing growth of search table size, requirements for reduced power consumption, and faster packet forwarding, systems and methods are desired for more efficient hash tables.

### BRIEF DESCRIPTION OF THE DRAWINGS/FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a block diagram of a hash system, in accordance with some embodiments,

FIG. 2A and 2B illustrate respective block diagrams of a logical view and a physical view of a hash table, in accordance with some embodiments.

FIGS. 3-5 illustrate block diagrams of a hash table and a control table, in accordance with some embodiments.

FIG. 6A and 6B illustrate forming of unique bit patterns (e.g. test bit positions) from keys, in accordance with an embodiment.

FIG. 7A illustrates a logical tree formed in organizing the unique bit patterns and corresponding keys in a bucket, in accordance with an embodiment.

FIG. 7B illustrates a table of example sizes of a control word that is stored for each bucket, in accordance with an embodiment.

FIGS. 8A and 8B graphically illustrates the incremental addition of unique bit patterns (e.g. test bit positions) when new keys are added to a bucket, in accordance with an embodiment.

FIG. 9 is a flowchart of a method for inserting a new key in a hash table, in accordance with an embodiment.

FIG. 10 is a flowchart of a method for looking up a key in a hash table, in accordance with an embodiment.

FIG. 11 is a flowchart of another method for looking up a key in a hash table, in accordance with an embodiment.

FIG. 12 is a flowchart of a method for forming a pivot to be stored in the control table, in accordance with an embodiment of the invention.

FIG. 13 is a flowchart of a method for determining a unique bit pattern (e.g. test bit positions) to be added when a new key is added to a bucket, in accordance with an embodiment.

### DETAILED DESCRIPTION OF THE INVENTION

While the present disclosure is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

Embodiments are directed to improving the utilization and power efficiency of hash tables in processing devices. Some embodiments provide for a hash table implementation where each hash table is configured with spare buckets, each of which can be logically chained to one or more buckets in the hash table. By providing, for each of the buckets within the bucket identifier range, one or more chained spare buckets, the number of hash entries that can map to a particular bucket identifier is increased. The increased number of hash entries associated with individual buckets leads to improved FMU.

Moreover, upon access to the hash table, some embodiments provide for reading a reduced set of entries when a bucket is selected. For example, instead of reading all entries of a bucket to which a hash function mapped, exactly one entry can be read using embodiments disclosed herein. Reading a single entry instead of the entire bucket results in substantial savings in dynamic power. Moreover, because access can be made to single entries, the hash table can be implemented with a narrower width (e.g. hash table width in physical memory set to the width of a single entry). Having narrower hash tables reduces the leakage power consumed. Thus, the embodiments disclosed herein provide for hash table implementations that result in improved utilization and power savings.

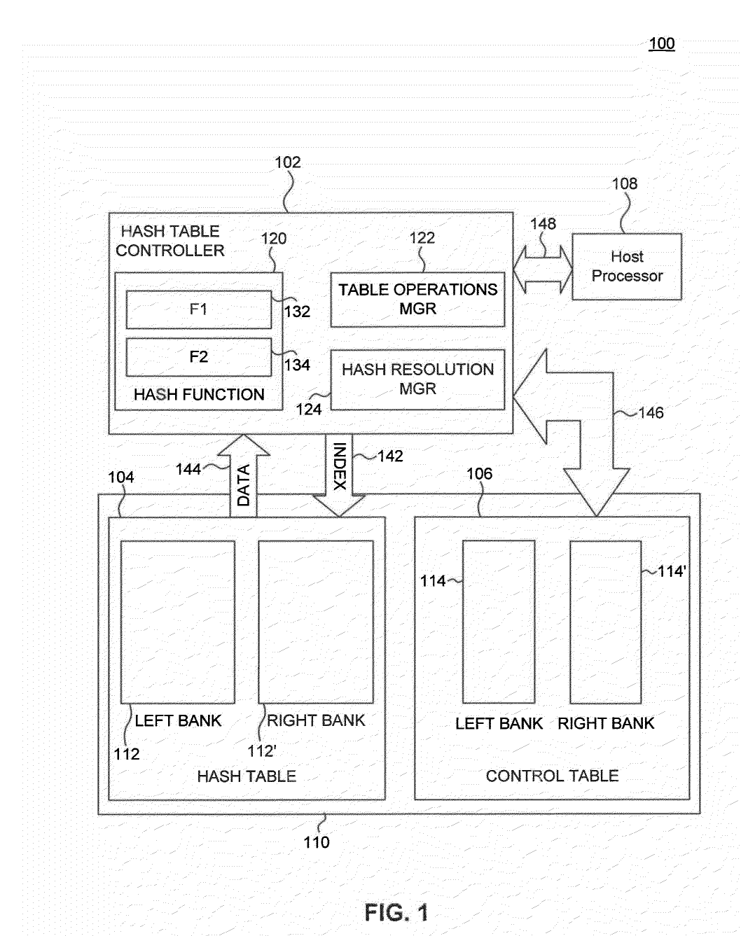

FIG. 1 illustrates a block diagram of a hash system 100, in accordance with an embodiment. Hash system 100 includes a bash table controller 102 coupled to a host processor 108 over an interface 148. Hash system 100 also includes a hash table 104 and a control table (also referred to as chain table) 106. Hash table 104 is configured with an input interface 142 through which hash table controller 102 provides hash indices for lookup and/or data for insert, and an output interface 144 through which data from the hash table is returned to the hash table controller. Control table 106 may be coupled to hash table controller 102 via an interface 146. In the illustrated embodiment, hash table 104 and control table 106 are in a memory 110.

Hash table 104 is configured to store tables of data entries, such as, but not limited to, one or both forwarding table entries and ACL entries, or other types of data that may be looked up by one or more applications.

Processor 108 can be a central processing unit (CPU) or other processor, and memory 110 can include any of, but is not limited to, dynamic random access memory (DRAM), static random access memory (SRAM), and hardware registers. Processor 108 is configured to use hash table controller 102 for some or all of its search operations. For example, processor 108 may rely upon hash table controller 102 for all of its forwarding table lookups and ACL lookups. Upon receiving a packet for which a table lockup, such as a forwarding table lookup or ACL lookup, is required, processor 108 may submit the search to hash table controller 102. Processor 108 may form a search key (e.g., search expression or search bit string, also referred to as a lookup key) from the packet's header fields which is then submitted to hash table controller 102.

Processor 108 transmits a search key to hash table controller 102 over interface 148 and receives an action or a lookup table entry (e.g. data) that matches the search key from hash table controller 102. Hash table controller 102 communicates with control table 106 and hash table 104 to obtain the lookup entry stored in hash table 104 corresponding to the search key received from processor 108. Processor 108 may also transmit data to be stored in hash table 104. Hash table controller 102 received the data to be stored, and communicates with control table 106 and hash table 104 to store the data in hash table 104 and update one or both, hash table 104 and control table 106 as required.

In the hash table controller 102, the search key is first processed in hash function module 120. Hash function module 120 may include one or more hash functions that take a search key as input, and determine a corresponding bucket identifier. Examples of hash functions are well known in the art, and any conventional or new hash function may be used in hash functions 132 and 134. In the example embodiment shown in FIG. 1, two hash functions 132 and 134 are configured in hash function module 120. The two hash functions 132 and 134 may be the same or may be different.

Consequently, hash function module 120 may be configured to implement a dual hashing technique in which each hash function 132 maps a received key to a different bucket identifier corresponding to a portion (e.g. bucket) of the hash table 104. The first hash function 132, for example, may be different from the second hash function 134. Consequently, each hash function 132, 134 may be operable to input a single key and output a corresponding bucket identifier value, thereby resulting in two different bucket identifier values.

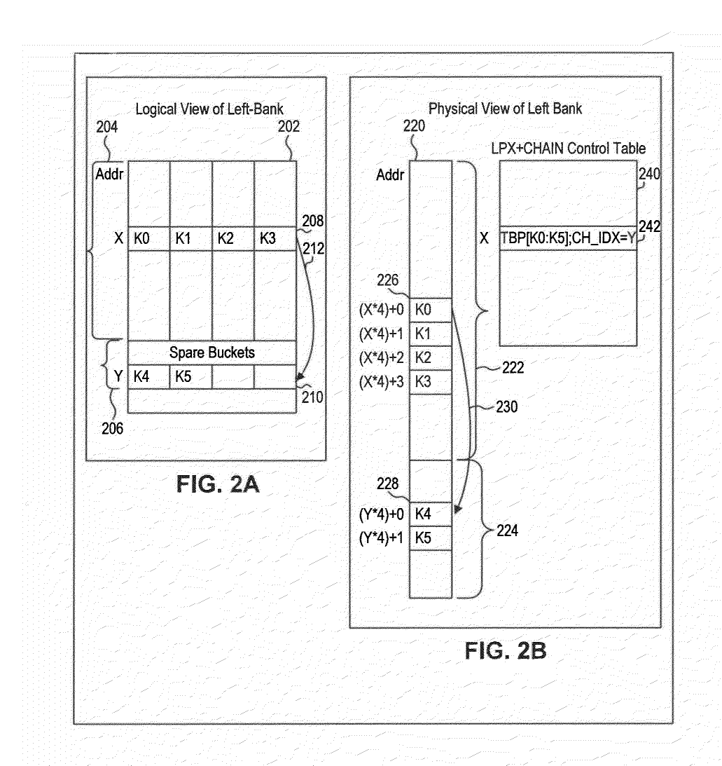

Specific examples of the hash table 104 are illustrated in detail below with respect to FIGS. 2-5. However, the hash table 104 of FIG. 1 illustrates that each of the two hash functions 132, 134 may correspond with associated subparts of hash table 104 referred to in FIG. 1 as banks of hash table 104, e.g., a first (left) bank 112 and a second (right) bank 112′. More specifically, it may be observed in FIG. 1 that the first hash function 132 corresponds to the first bank 112 of the hash table 104, and therefore may be used to hash a particular key and ultimately identify a first bucket index and an associated first entry of the first bank 112. Similarly, the second hash function 134 may be used by the hash function module 120 to hash the same search key to a second bucket index and corresponding second entry of the second bank 112′ of hash table 104.

In the example of FIG. 1, a table operations manager 122 is illustrated which is configured to perform various operations using the hash table 104. In specific examples described herein, such table operations may include, for example, insert (e.g. store) operations in which data values are inserted into the hash table 104, delete operations in which data values are deleted from the hash table 104, and lookup operations in which the data values are accessed from within the hash table 104. It will be appreciated, however, that such operations are merely non-limiting examples, and that other table operation for use of the hash table 104 may be executed for the table operations manager 122.

In the example of FIG. 1, the table operations manager 122 may be configured to execute an insert operation in conjunction with the above-described structure of the hash function 120 and the hash table 104. Specifically, as referenced above, the hash function 120 may execute the hash functions 132, 134 against a received key, to thereby determine a corresponding bucket index of the first entry and the corresponding bucket index of the second entry. Then, the table operations manager 120 may be configured to store the desired data value for the received key in one or the other of the first entry and the second entry.

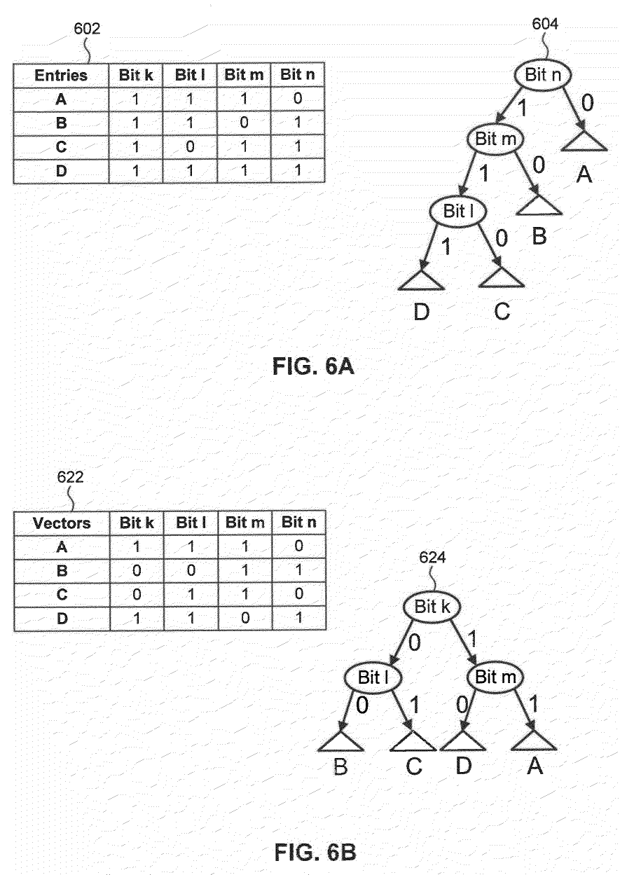

The hash resolution manager 124 operates to resolve the location in which a particular key is present. In an embodiment, the location of a particular key is resolved to a bucket and a particular entry in that bucket, represented respectively by a bucket identifier and a bucket entry identifier. As described below, in some embodiments, the control table 106 stores pivot information and entry identifying bit patterns (e.g. test bit positions or TBPs) for some buckets. The TBPs for a bucket are unique bit strings for each of the keys stored in that bucket. The hash resolution manager 124 can operate to determine the TBPs and control words associated with buckets. FIGS. 6-8 illustrate example TBPs and control words.

In the example of FIG. 1, hash table controller 102, hash table 104, and control table 108 are illustrated as being included in an apparatus 100. As would be appreciated by one of skill in the art, the apparatus 100 may represent virtually any data processing apparatus, or portion thereof, which may be used to implement the hash table controller 102, the hash table 104, and the control table 106. For example, the apparatus 100 may include a microchip(s) on which a processor 108 and one or more memories (e.g. memory 110) are included. For example, processor 108 may represent a central processing unit (CPU) and the memories may include random access memory (RAM) from which software instructions may be loaded to the processor 108.

In an example embodiment, one or more of hash table controller 102, hash table 104, and control table 106 may be implemented as hardware components of the apparatus 100. For example, hash table 104 and control table 106 may be constructing using hardware memories (e.g., registers and associated control elements). That is, such control elements may be considered to be included within the hash table controller 102, e.g., hash table operations manager 122 and the hash resolution manager 124. Further, the hash function module 120 also may be implemented in hardware, using components for executing the hash functions 132, 134.

Thus, in some implementations, it is possible to configure hash table controller 102 entirely in hardware to perform the functions described herein with respect to hash table 104 and control table 106. Nonetheless, hash table controller 102, or portions thereof, may be configured in software. In addition to items 102-108, hash system 100 may include one or more other processors and/or logic blocks. In some embodiments, hash 102 is formed on a single chip. System 100 may be part of a bridge, switch, router, gateway, server proxy, load balancing device, network security device, database server or other processing device.

FIG. 2A illustrates a logical view of a hash table 202, or more specifically, of a bank of a hash table (e.g. left bank 112), as one embodiment of hash table 104. Hash table 202 has a first portion. 204 of its buckets configured as the main part of the hash table where each bucket maps to a respective bucket identifier or range of bucket identifier values. A second portion 206 of hash table 202 is spare buckets that are not initially mapped to any bucket identifier. According to an embodiment, second portion 206 may be sized as a percentage (e.g. 10%) based upon the first portion 204. Any spare buckets in second portion 206 can be used to store entries that map to a particular bucket identifier, when the bucket that maps to that particular bucket identifier in the first portion is full. When a spare bucket is configured to store the overflow entries from a bucket in the first portion 204, that spare bucket is said to be “chained” to the bucket in the first portion 204.

According to some embodiments, any spare bucket can be chained to one or more buckets in first portion 204. Moreover, spare buckets can be chained to one another, providing a potentially large expansion of the number of entries that can be mapped to a bucket in the hash table, thereby substantially improving utilization.

As illustrated in the logical view of hash table 202 in FIG. 2A, buckets X and Y may be viewed as rows 208 and 210, each capable of storing four entries. Bucket X in the first portion 204 has stored in it keys K0, K1, K2 and K3. K0-K3 are keys that map respectively to bucket entry identifiers 0, 1, 2 and 3 of bucket X. Bucket X is, as shown, “full”. Spare bucket Y is chained, as shown by indicator 212, to bucket X and holds keys K4 and K5. K4 and K5 keys were mapped to bucket X, but were stored in chained spare bucket Y because bucket X is full.

FIG. 2B illustrates a physical view of hash table 220, in accordance with an embodiment. Items 202 and 220 may refer respectively to the logical and physical views of the same hash table instance. In some embodiments, the hash table can be configured in memory as a table having a width of a single entry. As described above, a narrower width can result in substantial power savings.

As described above in relation to the logical view, the physical view of hash table 220 can be viewed as a first portion 222 of buckets that map to a bucket identifier and a second portion 224 of spare buckets. Bucket X begins at 226 and spans four entries. Bucket Y, starting at 228, is chained 230 to bucket X.

FIG. 2B also illustrates a control table 240 as one embodiment of control table 106. Control table 240, as described above, stores chain information and other information needed to resolve the location of a search key. An entry in control table 240, corresponding to the bucket identifier for bucket X is populated with the chaining information for bucket X in hash table 220. The entry in the control table for bucket X, indicates that bucket X is chained to spare bucket Y (e.g. CH_IDX=Y). The entry also includes TBPs (e.g., TBP[K0:K5]) derived from the entries stored in buckets X and Y in the hash table 220. TBP and control words associated with buckets are described below in relation to FIGS. 6-8.

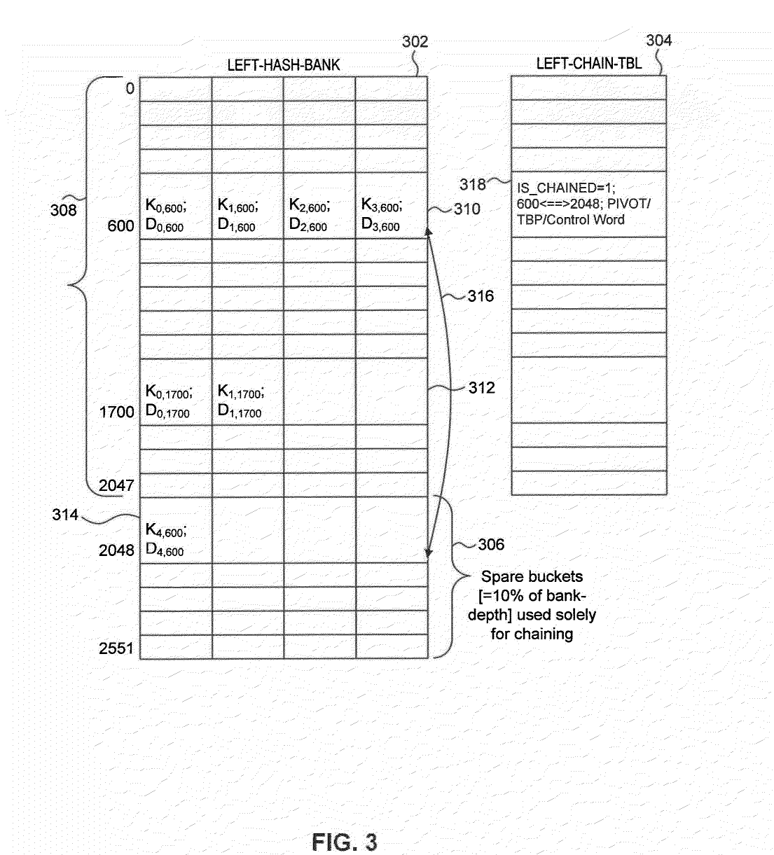

FIGS. 3-5 illustrate further details regarding the use of spare buckets, according to some embodiments. FIG. 3 illustrates a hash table (e.g. one of the banks of a hash table) 302, configured with 2048 buckets (e.g. bucket indexes 0-2047) in a first portion 308 that maps to a bucket identifier, and a second portion 306 of buckets that are identified as buckets 2048-2251. The second portion 306 has been configured to have a number of spare buckets that amounts to 10% of the first portion 308. Bucket 600 (item 310) is full having four stored keys. Bucket 600, as indicated by item 316, is chained to spare bucket 2048 (item 314). An entry in a corresponding control bucket 600 (item 318) in control table 304 is updated to indicate that bucket 600 in the first portion 308 is chained to spare bucket 2048 in the second portion 306. Note that the chain information stored in the control table 304 can be viewed as mapping (e.g. pointing) from a bucket in the first portion 308 to a spare bucket in the second portion 306 and vice versa (e.g. 600 to 2048 and 2048 to 600). It should also be noted that some entries in the first portion 308 of hash table 302, may only be partially full. Bucket 1700 (item 312), for example, has only two of its four entries filled at this instant. The notation (shown in FIGS. 3-5) K_{x,y} represents the x^{th} key in bucket y, and D_{x,y}), represents x^{th} data entry in bucket y. Each populated entry is indexed by the key and may store a data entry.

Control table 304, in addition to the chaining information (e.g. bucket 600 chained to bucket 2048) may also include other information that facilitate the resolution of bucket identifiers. As shown in 318, a pivot value may be stored in the corresponding entry in the control table, where the pivot provides a quick and efficient technique to determine whether a key that maps to a particular bucket in the first portion 308 is actually stored in the first portion 308 or in a chained spare bucket. According to an embodiment, the pivot is configured such that all keys having a value less than the pivot is in the corresponding bucket in the first portion 308 and all keys having a value equal to or greater than the pivot are stored in the corresponding chained spare bucket. Moreover, control table 304 can also include TBPs and control words that provide for identifying the precise entry corresponding to a search key. TBPs and control words are further described in relation to FIGS. 6-8.

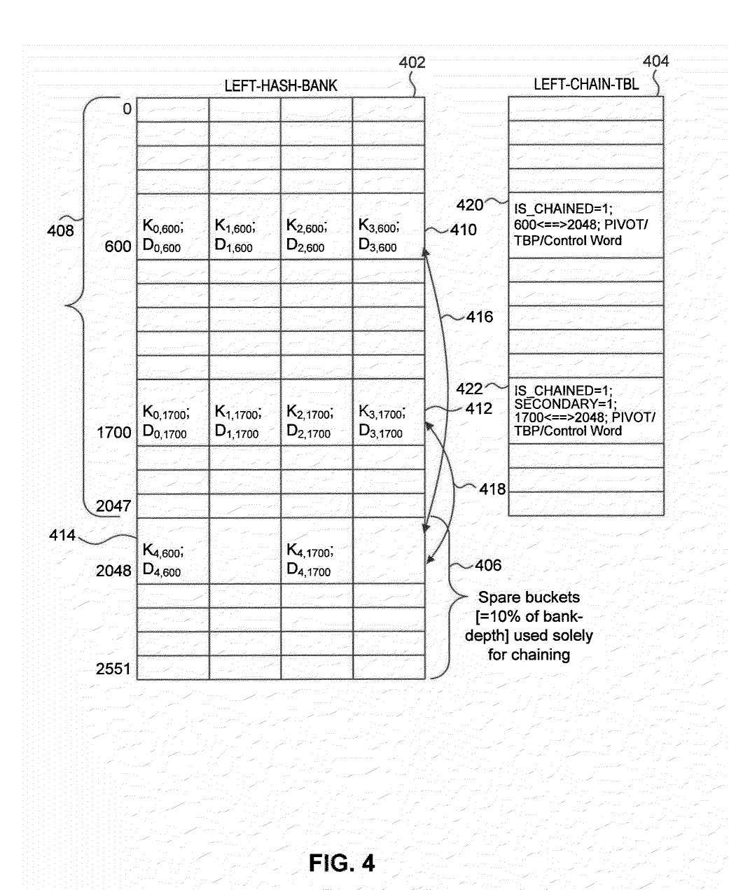

FIG. 4 illustrates an example where a spare bucket can be chained to more than one bucket in a hash table, in accordance with an embodiment. Similarly to hash table 302 and control table 304 described in relation to FIG. 3, hash table 402 includes a first portion 408 of buckets and a second portion 406 of spare buckets. Also, again similarly to FIG. 3, bucket 600 (item 410) in the first portion 408 is chained to spare bucket 2048 (item 414) and the corresponding entry (item 420) in control table 404 is updated to reflect the chaining. In addition, however, as shown in FIG. 4, spare bucket 2048 (item 414) is also chained (as shown by item 418) to bucket 1700 (item 412) in the first portion 408. The entry (item 422) corresponding to bucket 1700 in control table 404 is updated with the Chain information, pivot information, and any other information as described above. The sharing of spare buckets between buckets in the first portion 408 provides for better use of the available spare buckets to further improve the FMU.

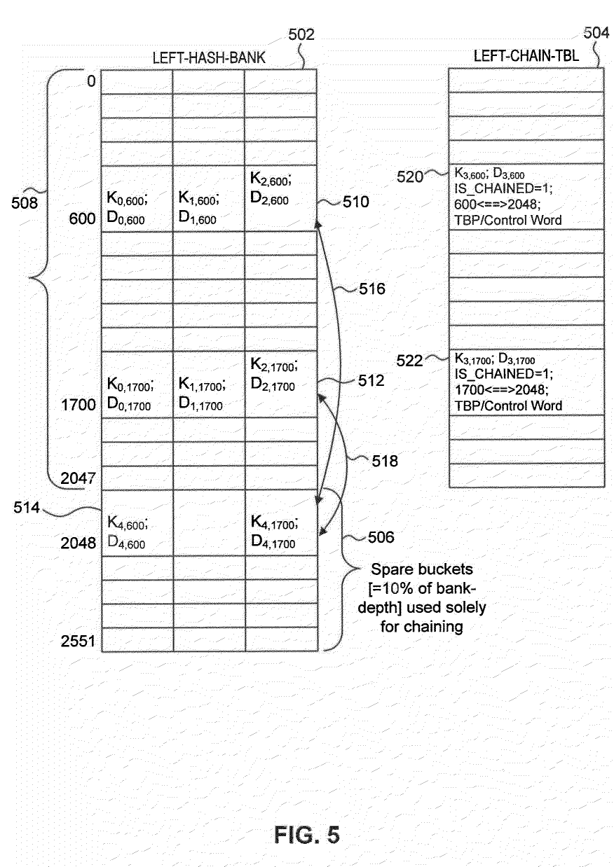

FIG. 5 illustrates an example where chaining and spare buckets are used to improve the EMU of a hash system, and where, in addition, the control table stores actual keys, in accordance with an embodiment. Hash table 502 is a table of 2252 buckets. Buckets are three entries wide (e.g. a bucket can store three keys). A first portion 508 of buckets map to the values produces by the hash function (bucket identifiers). A second portion 506 is spare buckets that are solely used as chained buckets to store the overflow entries from buckets in the first portion 508. Bucket 600 (item 510) is full having stored three entries, and is chained (as shown by item 516) to spare bucket 2048 (item 514). Bucket 1700 (item 512) from first portion 508 is also chained (as shown by item 518) to spare bucket 2048. The information regarding chains 516 and 518 are stored in the corresponding entries 520 and 522 in the control table 504. However, in addition to the information stored in the control table shown in FIGS. 3 and 4, control table 504 also includes stored keys. For example, key K_{3,600} is stored in the corresponding entry 520 for bucket 600 in the control table 504, instead of in the hash table 502. The keys stored in the control table operate as the pivot values described above, which determine what key values are stored in the bucket in the first portion of the hash table, and what keys are stored in the chained spare bucket(s).

FIGS. 6A and 6B illustrate the determination of the TBPs from keys stored in the buckets so that the precise entry that corresponds to a key can be identified, in accordance with an embodiment. As described above, the TBPs for a bucket are unique bit strings for each of the keys stored in that bucket. In an embodiment, the hash resolution manager 124 can operate to determine the TBPs.

Table 602 in FIG. 6A illustrate selected bit positions k, l, m and n of keys that may be stored in four entries (e.g. keys AD) in a bucket. The TBPs made of bit positions k, l, m and n for each key A-D is unique. Thus, regardless of the size of the actual corresponding keys, the set of TBPs shown in table 602 can uniquely identify each key A-D. D.

Resolution tree 604 illustrates an organization of the keys A-D based upon the TBPs 602. The ovals represent bit positions and triangles represent the keys. As illustrated in resolution tree 604, each key is represented by a leaf node (i.e., a node with no children). The tree can be configured to be of any shape.

The root of resolution tree 604, corresponding to bit n, indicates that of the four entries (A-D), only A has a 0 in bit position n, and the rest have a 1 in that position. Similarly each node may have two child branches classifying entries based upon their respective values at the corresponding bit positions. The tree organizing the bit positions can be used to determine the layout of the control word (e.g. 804 shows the formation of a control word) that provides for locating individual entries in hash buckets.

It should also be noted that, storing three bits (e.g., bits n, m and l) is sufficient in order to uniquely identify a key in a bucket of 4 entries.

Table 622 and corresponding logical tree 624 shown in FIG. 6B illustrate another scenario where the entries in a bucket yield a well-balanced tree. Again, note that three bits (e.g. bits k, l, and m) are sufficient to uniquely identify one of the keys A-D for which the respective TBPs are shown in table 622.

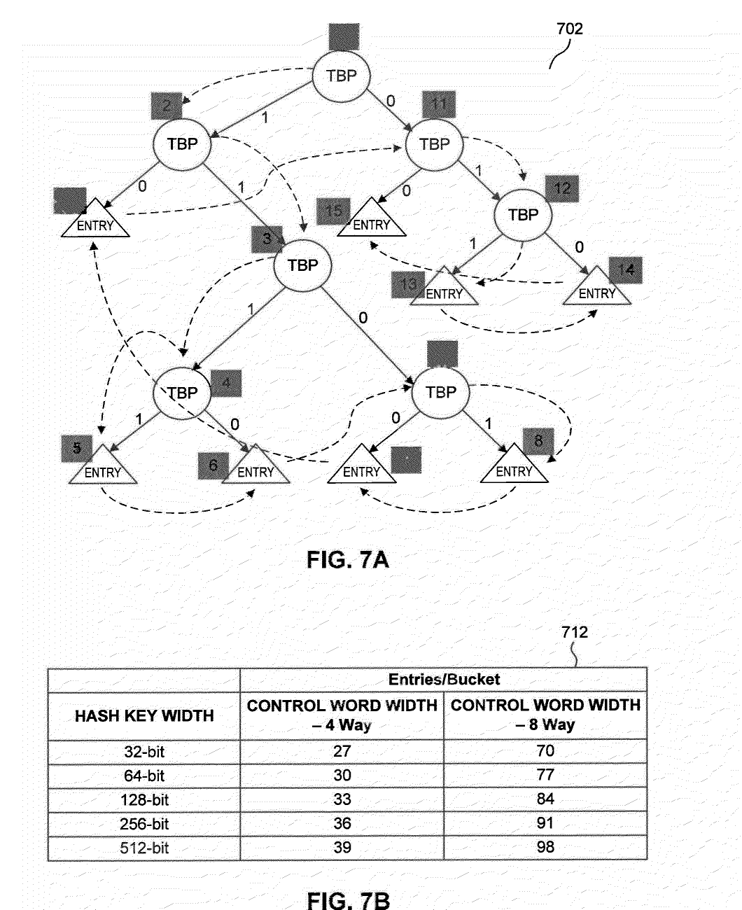

FIG. 7A illustrates a use of a resolution tree 702 derived from TBPs representing keys stored in a bucket to determine an organization (e.g. layout) of those keys in the bucket so that individual entries can be efficiently accessed, in accordance with an embodiment.

Resolution tree 702 includes 7 nodes representing 7 TBPs, and 8 leaf nodes representing the respective entries (e.g. stored keys). Tree 702 may be formed in the same or similar manner to that described with respect to FIGS. 6A-6B.

According to an embodiment, the bit positions and identifiers for the keys can be arranged in a control word (e.g. 804 illustrates the formation of a control word) in the sequence shown by the dotted-arrows on tree 702. In the example shown, starting at the root, branches corresponding to bit position value of 1 (alternatively, follow bit position value 0) are traversed until a key at a leaf node is encountered. The leafs (or the identifiers for the keys represented by them) are selected for including in the control word in the order that they are encountered during the tree traversal. After the first encountered leaf, in sequence, the tree leaf nodes or TBPs of the subtrees with the greatest depths having a longest common traversed path with the immediately preceding selected leaf is encountered.

For example, using tree 702 and following the path marked by the dotted arrows (the sequence of traversal is also indicated by the shaded numbers next to nodes and leafs), the following ordering of the entries may be obtained (entries identified by the shaded number adjacent to the tree leaves): 5, 6, 8, 9, 10, 13, 14, and 15.

FIG. 7B illustrates a table 712 showing the sizes of the control words that may be stored for various sizes of hash keys. As shown in table 712, the size of the control word may be different depending on the size of the bucket (i.e. associativity of, or number of entries in, the bucket). In accordance with some embodiments, such as when using a technique illustrated in FIG. 7A to construct the control word, the size of the control word increases only by a fixed number of bits even when the key doubles in size.

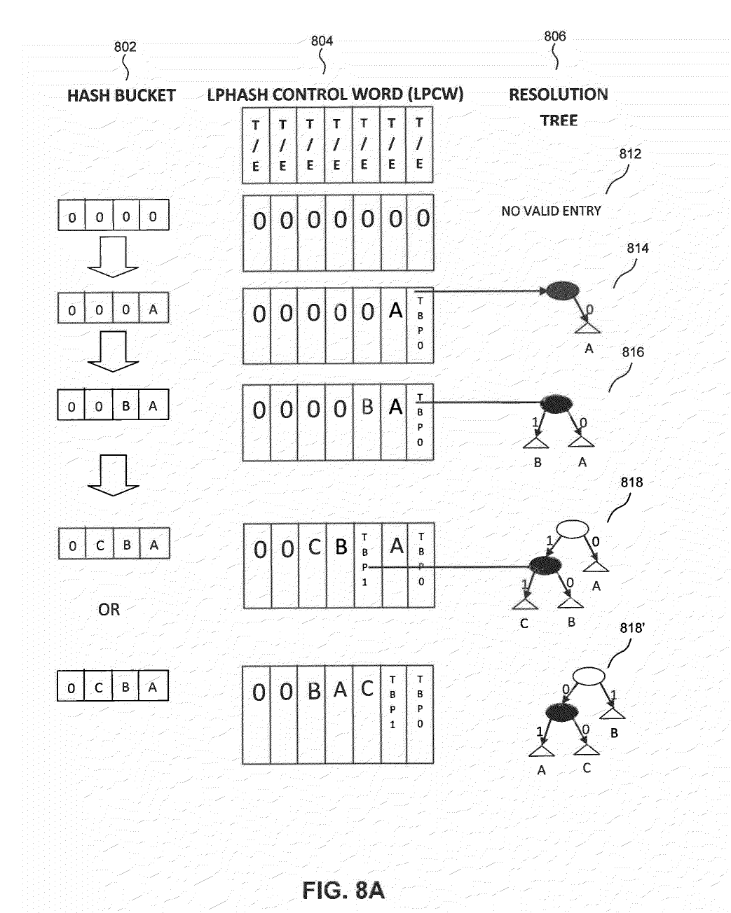

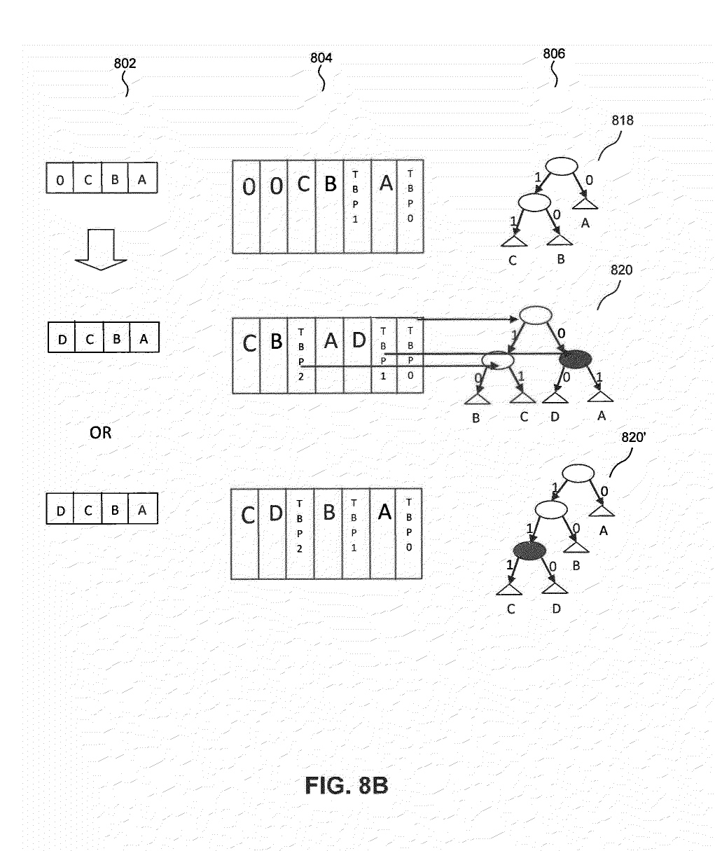

FIGS. 8A and 8B graphically illustrate the incremental TBP construction and control word forming, in accordance with an embodiment. FIG. 8A illustrates a sequence of hash buckets 802, control words 804, and resolution trees 806 that may be formed as entries are added to a bucket. The effect of each entry being added is illustrated by a corresponding hash bucket 802, control word 804 and resolution tree 806.

When the bucket is empty (i.e. no entries in the bucket), the control word is empty and there is no tree, as shown in 812.

As shown in 814, key A is added to the hash bucket as the first entry, the corresponding resolution tree is formed based upon a selected bit position in A With a value of 0, and the control word is updated by storing the selected bit position (“first selected bit position”) indicator (e.g., TBP0) and an identifier for key A. Note that the keys A-D used for the example in FIGS. 8A and 8B do not necessarily correspond to keys A-D used in the example of FIG. 7.

Next, as shown in 816, key B is added. Key B differs from key A at the first selected bit position, and therefore is simply added as the second branch of the current root of the tree. Accordingly, an identifier for B is added to the control word following the first selected bit position indicator, and the identifier for key A. The order in the control word, at 816, reflects the order of tree traversal: root, right branch (e.g. branch for bit value 0) to leaf A, and left branch to leaf B. In another embodiment, key A and B may not differ in the current first selected bit position, and therefore the current first selected bit position may be changed to a bit position in which keys A and B can be distinguished. If such a change to the first selected bit position is made, the order in the control word may be either first selected bit position, key A and key B, or first selected bit position, key B and key A, depending on which of key A and B have a value 0 at the first selected bit position.

Next, as shown in 818 and alternatively in 818′, key C is added to the bucket following A and B. 818 shows the tree and control word when C has a “11” in the first selected bit position and a second selected bit positions. Keys B and C differ in the second selected bit position. Thus, a subtree with the second selected bit position as root and keys B and C as child nodes is added as to the root node (the first selected bit position) of the current tree. Accordingly, in the control word, the currently existing identifier for key B is removed or overwritten for the subtree with the second selected bit position as root. The traversal for the tree at this stage may be, the first selected bit position, key A, the second selected bit position, key B, and key C.

818′ shows the tree and control word when C has a “00” in the first and second selected hit positions. Keys A and C differ in the second selected bit position. Thus, a subtree with the second selected bit position as root and keys A and C as child nodes is added to the root node (the first selected bit position) of the current tree. Accordingly, in the control word, the entries overwritten for the subtree with the second selected bit position as root. The traversal for the tree at this stage may be, the first selected bit position, the second selected bit position, keys C, A, and B. It should be noted that the first selected bit position in 818 has moved to become the second selected bit position in 820, and the newly determined TBP is represented as the first selected bit position.

Assuming the current configuration is as shown in 818, when key D is added to the bucket, the control word and tree may be as shown in 820 or, alternately, as 820′, 820 illustrates when key D differs from key A at a third selected bit position. The control word reflects the traversal of the tree: the first selected bit position, the second selected bit position, key D, key A, the third selected bit position, key B and key C.

820′ illustrates when key D differs from key C at the third selected bit position. The control word reflects the traversal of the tree: the first selected bit position, key A, the second selected bit position, key B, the third selected bit position, keys D and C. Note that the each of the first, second and third selected bit positions may represent, for example, any one of bits 0-127 in a 128-bit key.

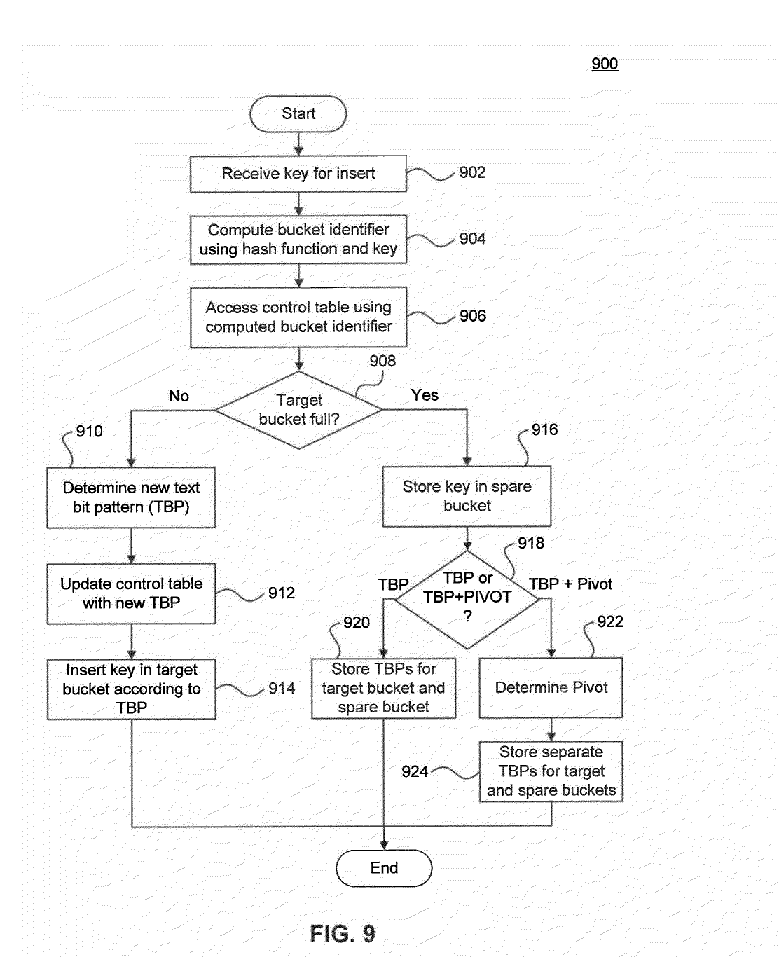

FIG. 9 is a flowchart of a method 900 of inserting a new key in a hash table, in accordance with an embodiment. Method 900 may be performed, for example, by hash table controller 102 to insert an entry (e.g. key and data) to hash table 104. One or more operations of 902-924 may not be mandatory. Operations 902-924 may be performed in an order different than that shown.

At operation 902, a key (e.g. insert key) is received. For example, a key is received at the hash table controller 102 from host processor 108.

At operation 904, a bucket identifier is determined. The bucket identifier may be determined by a hash function, such as one of hash function 132 or 134 shown in FIG. 1.

At operation 906, a control table is accessed using he determined bucket identifier. The control table may be a control table such as control table 106 shown in FIG. 1. According to an embodiment, if the bucket identifier is X, then the X'th entry of the control table is accessed.

At operation 908, it is determined whether the target bucket in the hash table is full. The “target bucket” is the bucket in the hash table that maps to the determined bucket identifier. According to an embodiment, the determination of whether the target bucket is full may be made based upon the control table. In some embodiments, the presence or absence of chain information (e.g. whether or not the bucket is chained to a spare bucket) can be used for the bucket fall/not full determination. In other embodiments, factors such as the number of TBPs representing the keys that are stored in the control table or a flag indicating whether or not the corresponding bucket is full may be used in the determination.

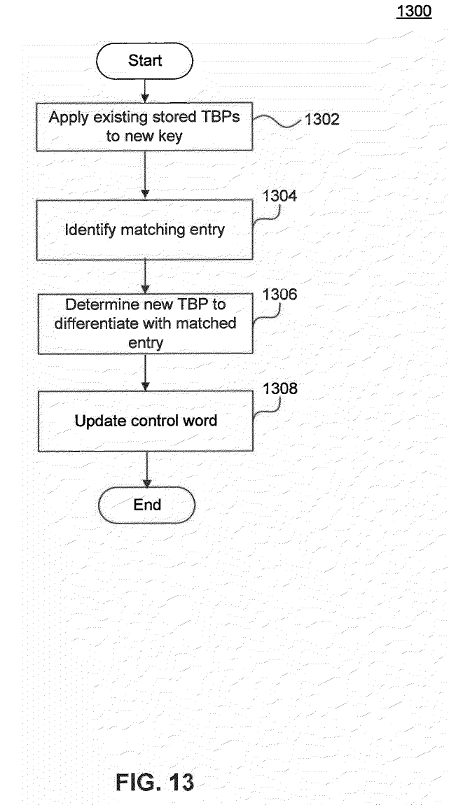

If, at operation 908, it is determined that the target bucket is not full, then at operation 910, a new TBP is determined for the key that is to be inserted in the hash table. The determination of a TBP for a newly added key is described above in relation to FIGS. 7 and 8 and below in relation to FIG. 13.

At operation 912, the control table is updated with the TBP for the new entry. As described above, a corresponding control word for each bucket of the hash table is maintained in the control table (or in the hash table). The formation of the control word is described above in relation to FIG. 8 (e.g. 804 illustrates the forming of an example control word).

At operation 914, the new entry is added to the bucket as determined by the bucket identifier.

if, at operation 908, it was determined that the target bucket was full, then method 900 proceeds to operation 916. At operation 916, the new key is stored in a spare bucket. Spare buckets were described in relation to FIG. 2 above.

The spare bucket may have already been selected (e.g. chained to the target bucket) in a previous operation. If the spare bucket has not yet been identified (e.g. the new entry is the first entry for the spare bucket), then select a spare bucket based upon some configured criteria. For example, the spare bucket with the lowest bucket index may be selected.

At step 918, it is determined whether the resolution of the bucket is to be made based only upon TBPs or whether it is to be made based upon TBPs and a pivot. In some embodiments, this may be a configuration option and a given hash system would operate only in one of the modes of resolution. In another embodiment, based upon the presence or absence of the pivot, applications can choose either mode.

If, at operation 918, it is determined that the hash table is to be resolved using only the TBPs, method 900 proceeds to operation 920. At operation 920 TBPs are determined for the target bucket and the spare bucket together, and stored together.

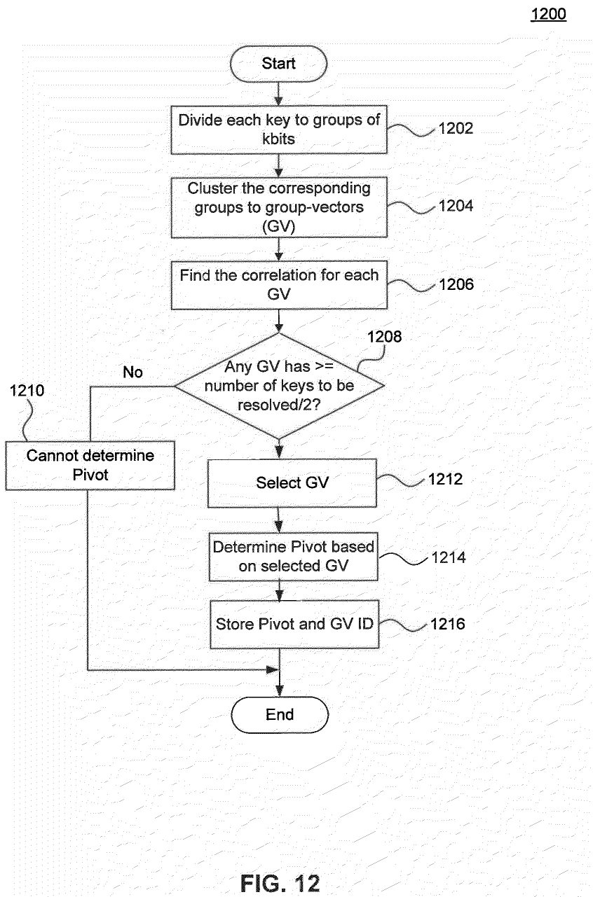

If, at operation 918, it is determined that the resolution is to be based upon the TBPs and the pivot, then method 900 proceeds to operation 922. At operation 922, a pivot is determined. As described above, a pivot may be selected so that all key values that map to the target bucket but are less than the pivot is stored in the target bucket and the other key values that map to the target bucket are stored in the spare bucket. The determination of a pivot is described above with respect to FIG. 2 and below with respect to FIG. 12. The determined pivot is stored in the corresponding entry in the control table. In some embodiments, along with the pivot, information needed to obtain a portion of the new key to be compared to the pivot is also stored. For example, as described below with respect to FIG. 12, the range of bit positions used to determine the pivot is stored with the pivot in the control table.

In some embodiments, if no pivot can be determined based on the current distribution of keys in the target bucket and the spare bucket, a reordering of at least some of the entries in the target bucket and the spare bucket may be performed. The pivot can then be determined based upon the reordered distribution of keys. The reordering may include software-based reordering of the keys.

At operation 924, separate TBP sets are determined and stored for the target bucket and spare bucket. The determination of TBPs is described above in relation to FIGS. 6 and 7,

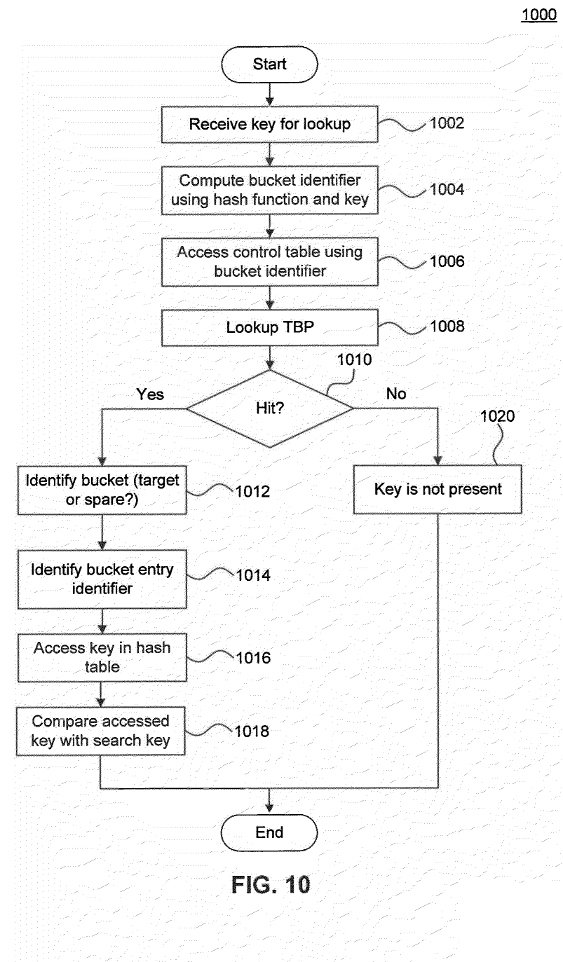

FIG. 10 is a flowchart of a method 1000 for looking up a key in a hash table, in accordance with an embodiment. Method 1000 may be performed, for example, by hash table controller 102 to lookup entry (e.g. key and data) to a hash table 104. One or more operations of 1002-1020 may not be mandatory. Operations 1002-1020 may be performed in an order different than that shown.

At operation 1002, a key (e.g. search key or insert key) is received. For example, a key is received at the hash table controller 102 from host processor 108.

At operation 1004, a bucket identifier is determined. The bucket identifier may be determined by a hash function, such as one of hash function 132 or 154 shown in FIG. 1.

At operation 1006, a control table is accessed using he determined bucket identifier. The control table may be a control table such as control table 106 shown in FIG. 1. According to an embodiment, if the bucket identifier is X, then the X′th entry of the control table is accessed.

At operation 1008, the TBPs stored in the control table are looked up. The lookup includes comparing a corresponding bit pattern derived from the search key to the TBPs stored in the corresponding entry in the control table.

At operation 1010, it is determined whether or not the compare operation resulted in a hit. It should be noted that, the bit pattern of the search key would at most match one TBP in the set of TBPs stored for the bucket. In some embodiments, the operation 1010 always returns a hit.

If at operation 1010, it is determined that the compare is a hit, then method 1000 proceeds to operation 1012. At operation 1012, the target bucket is identified. In this embodiment, the identification of the target bucket is based upon the TBPs. The target bucket is identified based upon which TBP (e.g. TBP for target bucket or TBP for spare bucket) is hit.

At operation 1014, the location of the matching entry within the bucket is identified. The location of the matching entry may be represented as a bucket entry identifier. This identification may be based upon the control word stored in the corresponding bucket of the control table. Control words are described above in relation to FIG. 8.

Having determined the target bucket and the location of the entry within the target bucket, at operation 1016, the entry is accessed in the hash table.

Following operation 1016, at operation 1018, the accessed key and the received key (e.g. search key) are compared to confirm the hit/match.

If, at operation 1010, it is determined that there was no hit for the search key in the TBPs, then at operation 1020, it is determined that the search key is not present in the hash table.

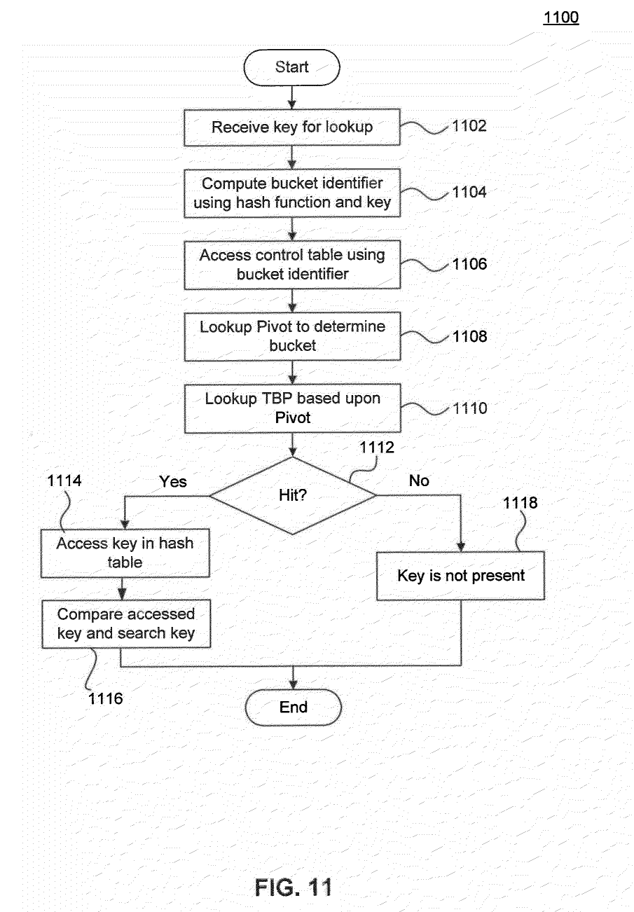

FIG. 11 is a flowchart of a method 1100 of looking up a key in a hash table, in accordance with an embodiment. Method 1100 may be performed, for example, by hash table controller 102 to lookup entry (e.g. key and data) to a hash table 104. One or more operations of 1102-1118 nay not be mandatory. Operations 1102-1118 may be performed in an order different than that shown.

At operation 1102, a key (e.g. search key or insert key) is received. For example, a key is received at the hash table controller 102 from host processor 108.

At operation 1104, a bucket identifier is determined. The bucket identifier may be determined by a hash function, such as one of hash function 132 or 134 shown in FIG. 1.

At operation 1106, a control table is accessed using the determined bucket identifier. The control table may be a control table such as control table 106 shown in FIG. 1. According to an embodiment, if the bucket identifier is X, then the X′th entry of the control table is accessed.

At operation 1108, the pivot is looked up in order to determine the bucket.

At operation 1110, the TBPs stored in the control table are looked up based upon the pivot. The pivot is used to identify which set of TBPs are to be compared to the search key. A separate set of TBPs is stored for the target bucket and the spare bucket. The lookup includes comparing a corresponding bit pattern derived from the search key to the TBPs stored in the corresponding entry in the control table. The forming of TBPs was described above in relation to FIG. 7.

At operation 1112, it is determined whether or not the compare operation resulted in a hit. It should be noted that, the bit pattern of the search key would at most match one TBP in the set of TBPs stored for the bucket. In some embodiments, the operation 1112 always returns a hit.

If, at operation 1112, a hit is detected, then at operation 1114, the matching entry within the bucket is identified. This identification may be based upon the control word stored in the corresponding bucket of the control table. Control words are described above in relation to FIG. 8.

Having determined the target bucket and the location of the entry within the target bucket, at operation 1116, the entry is accessed in the hash table and compared to the search key, for example, to confirm the hit.

If, at operation 1112, a hit is not detected (e.g. a miss occurs) than at operation 1118, it is determined that the search key is not present in the hash table.

FIG. 12 is a flowchart of a method 1200 of forming a pivot value to be stored in the control table, in accordance with an embodiment of the invention. Method 1200 may be performed, for example, by hash table controller 102 or a component thereof, such as, for example, hash resolution manager 124, to determine a pivot for a chained bucket. One or more operations of 1202-1214 may not be mandatory. Operations 1202-1214 may be performed in an order different than that shown.

As described above, the pivot enables a lookup operation to determine which bucket index (e.g. target bucket or chained spare bucket) is to be selected. The pivot can be a based upon a small portion of the keys which can be used to uniquely distinguish among the keys in the target bucket and the corresponding chained bucket. According to an embodiment, a pivot may be selected based upon a technique such as Group Vector Correlation. Method 1200 illustrates a method of determining a pivot for a chained bucket.

The keys stored in both buckets, the target bucket and the chained bucket, are considered. At operation 1202, each key is divided to groups of k-bits each. K can be preconfigured.

At operation 1204, corresponding ones of the groups are clustered to group vectors. For example, the first k-bits of each key belongs to a first cluster, the second k-bits of each key belongs to a second cluster, and so on. Thus, each group vector includes groups of k-bits where the k-bits are from the same bit positions. For example, group vector 0 may include groups of k-bits where k=0 . . . 15.

At operation 1206, a correlation measure is determined for each of the group vectors. The correlation can be based upon the number of unique values in the group vector.

At operation 1208, it is determined whether any of the group vectors have a number of unique values that is greater than or equal to half the number of keys to be resolved. For example, if a pivot is being sought for a target bucket and a spare bucket, each having 4 entries, then a group vector with four or more unique values is selected.

At operation 1212, one of the group vectors satisfying the test condition of operation 1208 is selected for deriving the pivot. The group vector selected may be any of the group vectors that satisfied the test condition. According to an embodiment, the selected group vector has the highest number of unique entries.

At operation 1214, the pivot is determined based upon the selected group vector. According to an embodiment, one of the values in the selected group vector can be chosen such that approximately half of the values in the group are less than the chosen value and the other half is equal to or greater than the chosen value.

At operation 1216, the chosen pivot value and the chosen group vector identifier is stored in the corresponding entry of the control table. The chosen group vector identifier is stored so that, at lookup time, the corresponding bits can be considered when determining the value of the search key to be compared against the pivot.

After operation 1216, method 1200 terminates.

If, at operation 1208, it is determined that no group vectors have the required number of unique values, then at operation 1210, it is determined that a pivot cannot be determined. Upon the determination that no pivot is available, chaining may not be performed for that pair of buckets. After operation 1210, method 1200 terminates.

FIG. 13 is a flowchart of a method 1300 of determining a TBP to be added when a new key is added to a bucket, in accordance with an embodiment. Method 1300 may be performed, for example, by hash table controller 102 or a component thereof, such as, for example, hash resolution manager 124, to incrementally determine a TBPs to be stored in the control table. One or more operations of 1302-1308 may not be mandatory. Operations 1302-1308 may be performed in an order different than that shown.

The method works by finding bits that differ in the group of entries and stores the positions of such bits. These stored bit-positions are referred to as Test Bit Positions or TBPs. The essential characteristics of the algorithm are: no false negatives, free of aliasing issues, and scalable for multi-way bash tables.

Method 1300 may be performed upon the initiation of an insert operation. Method 1300 starts at operation 1302. At operation 1302, the existing TBPs for the corresponding bucket(s) are read and applied to the new key.

At operation 1304, a matching entry is determined. There can be only one existing entry that matches the new entry to be added at all of the existing TBPs. The new TBP to be determined is the one that differentiates these two entries. This is the basic principle of operation of the incremental TBP update method.

At operation 1306, a new TBP for the new key is determined in order to differentiate the new entry from the matched entry. In embodiments, only a single one of the existing entries are accessed in order to update the control word. For example, the sole matching entry is read out and a TBP differentiating it from the incoming entry is stored.

At operation 1308, the control word is updated for the corresponding bucket in accordance with the revised set of TBPs. A control word is maintained for each hash bucket in the hash table. This control word consists of the TBPs and identifiers (e.g. pointers) to the individual entries in the hash bucket as resolved by the TBPs. The order in which the TBPs and the entry identifiers are specified in the control word is a function of a resolution tree encountered for the particular hash bucket. Updating the control word may include forming a resolution tree based upon the revised set of TBPs and traversing that resolution tree in order to determine how the TBP and identifiers to corresponding entries are to be stored in the control word. The forming of the resolution tree and the traversal of it to determine the control word is described above in relation to FIG. 8.

As would be appreciated by one of skill in the art, implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

The representative functions of the has system described herein may be implemented in hardware, software, or some combination thereof. For instance, methods 900, 1000, 1100, 1200 and 1300 can be implemented using computer processors, computer logic, ASIC, FPGA, DSP, etc., as will be understood by those skilled in the arts based on the discussion given herein. Accordingly, any processor that performs the processing functions described herein is within the scope and spirit of the present invention.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
inserting a key in a selected bucket in accordance with a bucket identifier generated by a hash function, wherein the selected bucket is one of a plurality of buckets of a hash table configured in at least one memory;
determining respective unique bit strings based upon corresponding bit positions for a plurality of keys in the selected bucket, the plurality of keys including the inserted key; and
inserting the respective unique bit strings in a table location corresponding to the bucket identifier, wherein the table location is one of a plurality of table locations in at least one control table configured in the at least one memory.

2. The method of claim 1, wherein the plurality of buckets of the hash table includes a main plurality of buckets and a spare plurality of buckets, and wherein the inserting the key comprises:
determining the bucket identifier by providing the key as an input to the hash function, wherein the bucket identifier is between a start index value and an end index value; and
accessing the selected bucket in the spare plurality of buckets based upon a pointer in the at least one control table in a location corresponding to the bucket identifier, wherein one or more buckets in the spare plurality of buckets are linked to buckets in the main plurality of buckets based upon pointers in corresponding locations in the at least one control table, and wherein buckets in the main plurality of buckets directly correspond to at least one value between the start index value and the end index value.

3. The method of claim 1, wherein the inserting the key comprises:
determining the bucket identifier by providing the key as an input to the hash function, wherein the bucket identifier is between a start index value and an end index value, and wherein the plurality of buckets of the hash table includes a main plurality of buckets and a spare plurality of buckets;
detecting that a bucket corresponding to the bucket identifier in the main plurality of buckets is full;
responsive to the detecting, storing the key in a bucket entry of the selected bucket in the spare plurality of buckets; and
writing a pointer to the selected bucket in an entry in the at least one control table in a location corresponding to the bucket identifier.

4. The method of claim 3, wherein the inserting the key further comprises:
determining a pivot corresponding to the selected bucket, wherein the pivot separates key values in the bucket corresponding to the bucket identifier in the main plurality of buckets and key values in the selected bucket; and
writing the pivot in the entry in the at least one control table.

5. The method of claim 4, wherein the inserting the key farther comprises:
re-organizing keys in the selected bucket and in the bucket corresponding to the bucket identifier in the main plurality of buckets, wherein the re-organizing is performed before the determining the pivot.

6. The method of claim 4, wherein the determining a pivot comprises:
determining the pivot based upon respective portions of the plurality of keys in the selected bucket.

7. The method of claim 4, wherein the determining a pivot comprises:
selecting one of the plurality of keys in the selected bucket as the pivot, and
wherein the selected one of the plurality of keys in the selected bucket is stored in the table location corresponding to the bucket identifier in the at least one control table.

8. The method of claim 1, wherein the determining respective unique bit strings comprises:
determining, incrementally for respective ones of the plurality of keys, a plurality of bit positions that yields a respective one of the unique bit strings.

9. The method of claim 8, wherein the determining respective unique bit strings further comprises:
determining an ordering of identifiers for the plurality of keys and the respective unique bit strings to form a control word corresponding to the selected bucket.

10. The method of claim 1, wherein the inserting the respective unique bit strings comprises:
storing a control word corresponding to the selected bucket, wherein the control word includes the respective unique bit strings and identifiers for the plurality of keys.

11. A method, comprising:
determining a bucket identifier generated by a hash function for a key;
accessing a control table in a memory using the bucket identifier;
determining a bit string from the key, wherein the bit string is formed based upon a subset of bit positions of the key;
determining a bucket entry identifier based upon the bit string and the bucket identifier, wherein the bucket identifier corresponds to a selected bucket in a hash table; and
accessing a selected bucket entry in the selected bucket using the bucket entry identifier.

12. The method of claim 11, wherein the method further comprises:
comparing the key to a pivot stored in the control table; and
responsive to the comparing, determining the selected bucket.

13. The method of claim 11, wherein the method further comprises:
comparing a portion of the key to a pivot stored in the control table, wherein the portion is determined based upon information stored in the control table in a location corresponding to the bucket identifier; and
responsive to the comparing, determining the selected bucket.

14. The method of claim 11, wherein the determining a bucket entry identifier comprises:
comparing the bit string to a plurality of unique bit strings stored in the control table in a location corresponding to the bucket identifier, wherein the plurality of unique bit strings include respective bit strings for a plurality of keys stored in the selected bucket; and
identifying one of the plurality of keys stored in the selected bucket based upon the comparing.

15. A system, comprising:
a hash table configured in at least one memory;
a control table configured in the at least one memory; and
a hash table controller configured to:
insert a key in a selected bucket in accordance with a bucket identifier generated by a hash function, wherein the selected bucket is one of a plurality of buckets of a hash table configured in at least one memory;
determine respective unique bit strings based upon corresponding bit positions for a plurality of keys in the selected bucket, the plurality of keys including the inserted key; and
insert the respective unique bit strings in a table location corresponding to the bucket identifier, wherein the table location is one of a plurality of table locations in at least one control table configured in the at least one memory.

16. The system of claim 15, wherein the plurality of buckets of the hash table includes a main plurality of buckets and a spare plurality of buckets, and wherein the hash table controller is further configured to:
determine the bucket identifier by providing the key as an input to the hash function, wherein the bucket identifier is between a start index value and an end index value; and
access the selected bucket in the spare plurality of buckets based upon a pointer in the at least one control table in a location corresponding to the bucket identifier, wherein one or more buckets in the spare plurality of buckets are linked to buckets in the main plurality of buckets based upon pointers in corresponding locations in the at least one control table, and wherein buckets in the main plurality of buckets directly correspond to at least one value between the start index value and the end index value.

17. The system of claim 15, wherein the hash table controller is further configured to:
determine, incrementally for each of said all keys, a plurality of bit positions that yields a respective one of the unique bit strings.

18. The system of claim 17, wherein the hash table controller is further configured to:
determine an ordering of identifiers for said all keys and the respective unique bit strings to form a control word corresponding to the selected bucket.

19. A non-transitory computer readable storage medium storing instructions that, when executed by a processor, performs a method comprising:
inserting a key in a selected bucket in accordance with a bucket identifier generated by a hash function, wherein the selected bucket is one of a plurality of buckets of a hash table configured in at least one memory;
determining respective unique bit strings based upon corresponding bit positions for a plurality of keys in the selected bucket, the plurality of keys including the inserted key; and
inserting the respective unique bit strings in a table location corresponding to the bucket identifier, wherein the table location is one of a plurality of table locations in at least one control table configured in the at least one memory.

20. The non-transitory computer readable storage medium of claim 19, wherein the plurality of buckets of the hash table includes a main plurality of buckets and a spare plurality of buckets, and wherein the inserting the key comprises:
determining the bucket identifier by providing the key as an input to the hash function, wherein the bucket identifier is between a start index value and an end index value; and
accessing the selected bucket in the spare plurality of buckets based upon a pointer in the at least one control table in a location corresponding to the bucket identifier, wherein one or more buckets in the spare plurality of buckets are linked to buckets in the main plurality of buckets based upon pointers in corresponding locations in the at least one control table, and wherein buckets in the main plurality of buckets directly correspond to at least one value between the start index value and the end index value.
